(19) United States
(12) Patent Application Publication
(10) Pub. No.: US 2004/0213215 A1
(43) Pub. Date: Oct. 28, 2004

(54) IP telephony service system and accounting method

(75) Inventor: Motofumi Kakiuchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/832,276

(22) Filed: Apr. 27, 2004

(30) Foreign Application Priority Data
Apr. 28, 2003 (JP) 123714/2003

(51) Int. Cl. H04Q 11/00

(52) U.S. Cl. 370/352

(57) ABSTRACT

An IP telephony service system and an accounting method in order to charge for telephony services provided during backup operation. When communications between IP terminals and an IP telephony service providing unit in the main network are interrupted, an IP telephony service backup unit placed in a LAN to which the IP terminals are connected provides IP telephony services to the IP terminals. Information on the services provided to the IP terminals by the IP telephony service backup unit is stored in a backup database. Thus, it becomes possible to charge for the services provided during backup operation.

### FIELD OF THE INVENTION

The present invention relates to an IP telephony service system and an accounting method, and in more particular, to an IP telephony service system and a method of charging for IP telephony services which are provided especially when failures occur.

### BACKGROUND OF THE INVENTION

There is found an example of a backup system in Japanese Patent Application laid open No. 2003-22258. The backup system comprises a plurality of servers, which provide services in response to requests from users. Each server has the server function of another server in addition to its own function so as to carry out the server function on behalf of the other server when failures occur in the other server.

A description will be made of a conventional IP telephony service system including such backup system with reference to FIG. 1.

The system shown in FIG. 1 comprises a WAN 500 for connecting respective offices and a plurality of LANs 400, 410 and 420 in the respective offices, each being connected with the WAN 500. In the system, the LAN 400 is a network provided to a main office or the like, and terminals connected to the LAN 400 operate as main units. On the other hand, the LANs 410 and 420 are networks provided to remote offices.

The LAN 400 includes an IP telephony service providing unit 100 (server, IP-PBX, etc.) for offering telephony services to IP phones and the like, and a main database 600 for managing or maintaining service information such as telephone records in the entire telephony system. The LANs 410 and 420 include IP telephony service backup units 110 and 120 set in the respective remote offices. Further, the LANs 400, 410 and 420 include IP terminals 200, 201, 210, 211, 220, and 221 (IP phones, IP Soft phones, IP PHS base stations, etc.) used in the respective offices, and routers 300, 310 and 320 for connecting to the WAN 500.

For example, it will be assumed that a failure occurred in the WAN 500, and communications between the router 300 and the router 310 have been cut off. In this abnormal condition, the IP terminals (210 and 211) in the remote office 1 is unable to communicate with the IP telephony service providing unit 100 in the main office and therefore utterly unable to use telephony services (calls or conversations via internal lines or on extensions, etc.).

On such an occasion, if the remote office 1 is provided with the IP telephony service backup unit 110, the IP terminals (210 and 211) can continue to use the telephony services even after the occurrence of the failure or in the abnormal condition by communicating with the IP telephony service backup unit 110.

Failures may occur in the respective routers (300, 310 and 320), the IP telephony service providing unit 100 in the main office and the like, and cause the abnormal condition of the networks.

However, in the conventional IP telephony service backup system, there is a problem as follows.

In the IP telephony service backup system, the main database 600 of the IP telephony service providing unit 100 unifies the management of information such as telephone records utilized for service accounting. However, the main database 600 is not provided with a mechanism for collecting the information during backup operation. Consequently, it is impossible to charge for the services which are provided while the backup operation is carried out.

### SUMMARY OF THE INVENTION

It is therefore an object of the present invention to provide an IP telephony service system and an accounting method, in which, when a network recovers from failures, an IP telephony service providing unit in a main office is informed of telephone records and the like at remote offices during backup operation for IP telephony services so that the charges for the telephony services supplied during the backup operation can be made.

In accordance with an aspect of the present invention, to achieve the above objects, there is provided an IP telephony service system for offering IP telephony services to IP terminals, comprising a main network and a plurality of sub networks, wherein the main network includes an IP telephony service providing unit for providing IP telephony services to IP terminals, and each of the sub networks includes an IP telephony service backup unit for providing IP telephony services when communications between the IP terminals and the IP telephony service providing unit in the main network are interrupted.

The main network may include a first database for storing service information or information on services provided to the IP terminals in cooperation with the IP telephony service providing unit, and each of the sub networks may include a second database for storing information on services provided to the IP terminals by the IP telephony service backup unit in cooperation with the IP telephony service backup unit.

The service information stored in the second database may be forwarded to the first database so as to be stored therein when the IP telephony service providing unit resumes the IP telephony service.

Besides, the main network may include a first service information management unit for storing and managing service information or information on services provided to the IP terminals, and each of the sub networks may include a second service information management unit for storing and managing information on services provided to the IP terminals by the IP telephony service backup unit.

In this case, the service information stored in the second service information management unit may be forwarded to the first service information management unit so as to be stored therein when the IP telephony service providing unit resumes the IP telephony service.

The IP telephony service providing unit may have a first storage for storing service information or information on services provided to the IP terminals, and the IP telephony service backup unit may include a second storage for storing information on services provided to the IP terminals by the IP telephony service backup unit.

In this case, the service information stored in the IP telephony service backup unit may be forwarded to the IP telephony service providing unit so as to be stored therein when the IP telephony service providing unit resumes the IP telephony service.

In accordance with another aspect of the present invention, there is provided an accounting method for an IP telephony service system that offers IP telephony services to IP terminals, comprising the steps of: providing IP telephony services to IP terminals through an IP telephony service providing unit placed in a main network, and storing service information fed by the IP telephony service providing unit in a first storage placed in the main network; or providing IP telephony services to IP terminals through an IP telephony service backup unit placed in a sub network where the IP terminals are connected when communications between the IP terminals and the IP telephony service providing unit in the main network are interrupted, and storing service information fed by the IP telephony service backup unit in a second storage placed in the sub network.

The accounting method may further comprise the step of forwarding the service information which was stored in the second storage while communications between the IP terminals and the IP telephony service providing unit in the main network were interrupted to the first storage to store the information therein when the IP telephony service providing unit resumes the IP telephony service.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the construction of a conventional IP telephony service system;

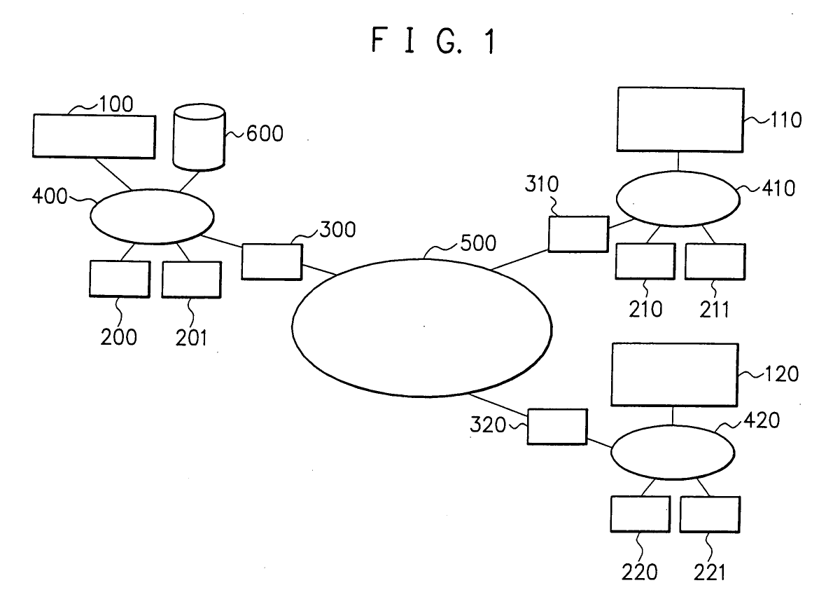

FIG. 2 is a block diagram showing the construction of an IP telephony service system according to the first embodiment of the present invention;

FIG. 3 is a block diagram showing the construction of an IP telephony service system according to the second embodiment of the present invention;

FIG. 4 is a block diagram showing the construction of an IP telephony service system according to the third embodiment of the present invention;

FIG. 5 is a block diagram showing the construction of an IP telephony service system according to the fourth embodiment of the present invention; and

FIG. 6 is a flowchart showing the operation of the IP telephony service system.

### DESCRIPTION OF THE PREFERRED EMBODIMENTS

Referring now to the drawings, a description of preferred embodiments of the present invention will be given in detail. Like reference numerals refer to corresponding parts throughout the drawings.

The present invention is characterized in that, in IP telephony service backup operation for remote offices, information such as telephone records, which has been lost in a conventional system, is made available after recovery from the backup state, and therefore, it becomes possible to charge for services provided during backup operation.

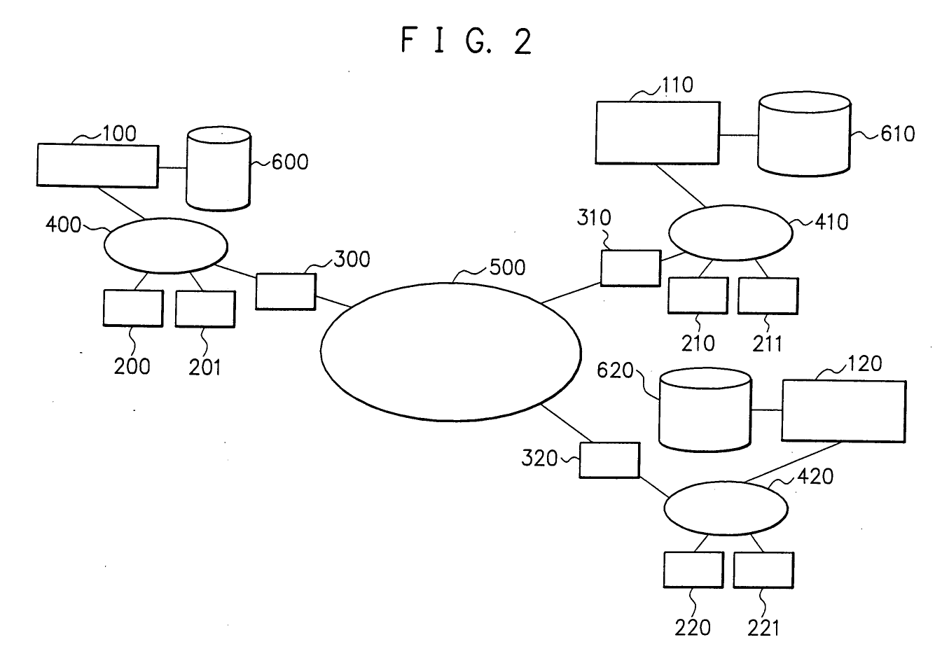

FIG. 2 is a block diagram showing the construction of an IP telephony service system according to the first embodiment of the present invention.

Referring to FIG. 2, the IP telephony service system comprises an IP network such as a WAN 500 for connecting respective offices and a plurality of LANs 400, 410 and 420 in the respective offices, each being connected with the WAN 500. In the system, the LAN 400 is a network provided to a main office or the like. On the other hand, the LANs 410 and 420 are networks provided to remote offices.

The LAN 400 includes an IP telephony service providing unit 100 and a main database 600. The IP telephony service providing unit 100 is a server, an IP-PBX or the like on which an application for offering telephony services to IP phones is installed. The main database 600 is connected to the IP telephony service providing unit 100, and stores service information such as telephone records in the entire IP telephony service system.

The LANs 410 and 420 include one each of IP telephony service backup units 110 and 120, and backup databases 610 and 620. The IP telephony service backup units 110 and 120 are set in the respective remote offices to serve as backups for the IP telephony service providing unit 100. An IP telephony service backup application is installed on each of the IP telephony service backup units 110 and 120. The backup databases 610 and 620 are connected to the IP telephony service backup units 110 and 120, respectively, and store service information such as telephone records during backup operation. Further, the LAN (400, 410 and 420) includes IP terminals (200, 201, 210, 211, 220, and 221) such as IP phones, IP Soft phones, IP PHS base stations, and the like used in the respective offices, and a router (300, 310 and 320) for connecting to an IP network such as the WAN 500.

When communications with the IP telephony service providing unit 100 have been cut off due to, for example, a failure or traffic congestion in the WAN 500, the IP telephony service backup units (110 and 120) perform backup operation. During the backup operation, information on services provided to the IP terminals (210, 211, 220 and 221) in the respective remote offices is stored in the backup databases (610 and 620). Thereby, it becomes possible to charge for the services provided during the backup operation. Incidentally, the service information stored in the backup databases (610 and 620) during the backup operation may be forwarded to the main database 600 at regular intervals or after the WAN 500 recovers from the failure, and registered with the database 600.

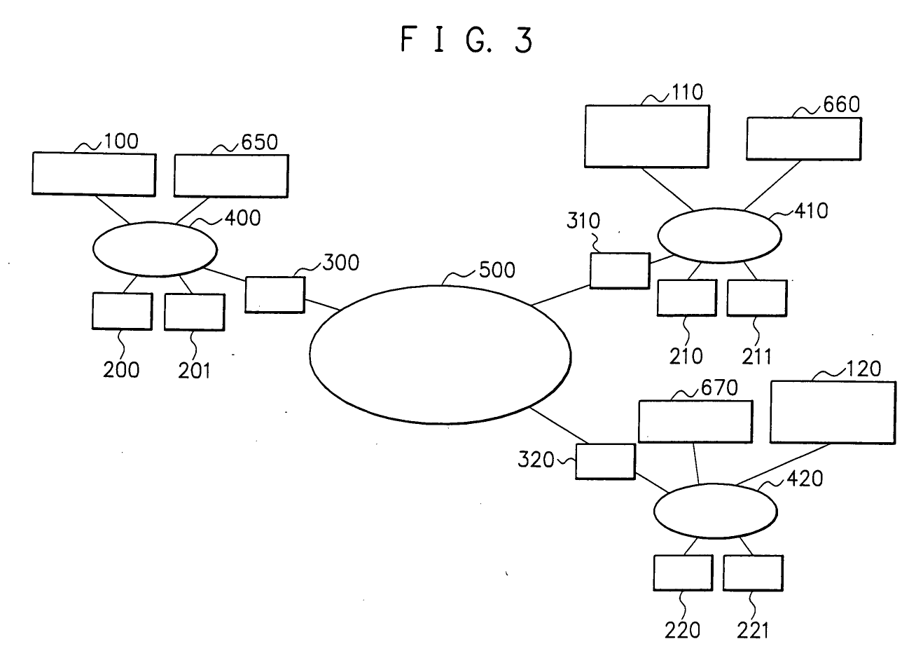

FIG. 3 is a block diagram showing the construction of an IP telephony service system according to the second embodiment of the present invention. As can be seen in FIG. 3, the IP telephony service system of the second embodiment has essentially the same construction as described previously in connection with FIG. 2 except for the presence of a main service information management unit 650 and sub service information management units 660 and 670 instead of the databases.

The main service information management unit 650 is a unit on the network, which operates in cooperation with the IP telephony service providing unit 100, or an application (a virtual unit implemented in software) installed on the unit 100. In other words, the main service information management unit 650 may be placed either inside or outside the IP telephony service providing unit 100. The main service information management unit 650 manages or maintains service information such as telephone records in the entire IP telephony service system.

The sub service information management units 660 and 670 are units on the network, which operate in cooperation with the IP telephony service backup units 110 and 120, respectively, or applications (virtual units implemented in software) installed on the units 110 and 120. In other words, the sub service information management unit 660 and 670 may be placed either inside or outside the IP telephony service backup units 110 and 120. The sub service information management units 660 and 670 store service information such as telephone records during backup operation.

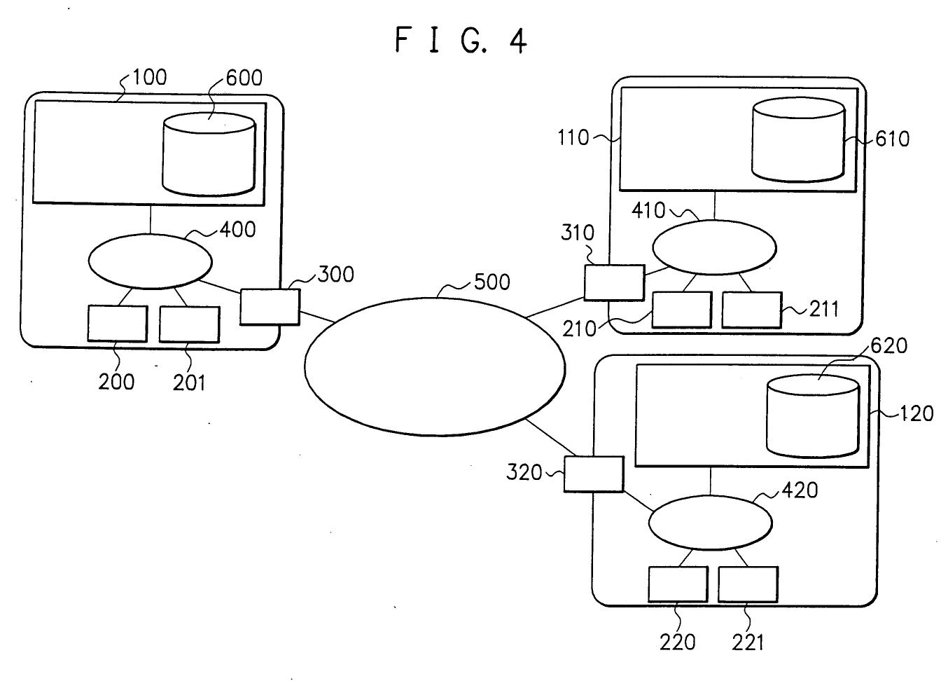

FIG. 4 is a block diagram showing the construction of an IP telephony service system according to the third embodiment of the present invention. In this embodiment, the main office is provided with an IP- PBX as the IP telephony service providing unit 100. As can be seen in FIG. 4, the third embodiment is characterized in that the IP telephony service providing unit 100 and the IP telephony service backup units 110 and 120 include the databases 600, 610 and 620 for managing or maintaining service information, respectively.

The IP telephony service backup units 110 and 120 in the respective remote offices provide telephony services in the abnormal condition as for example when failures or trouble occur in the WAN 500, and stores information on the provided services (calls, etc.). Incidentally, the method for implementing the IP telephony service is known in the art, and since it does not enter into the present invention, it will not described herein.

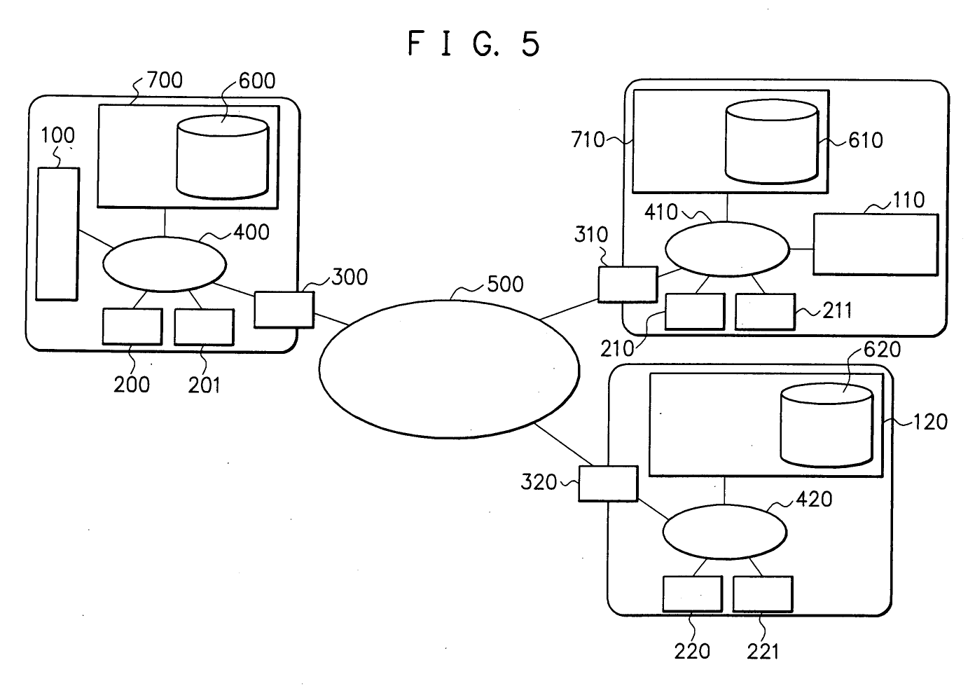

FIG. 5 is a block diagram showing the construction of an IP telephony service system according to the fourth embodiment of the present invention. In this embodiment, the IP telephony service providing unit 100 and the IP telephony service backup unit 110 are not provided with the database for managing or maintaining service information, and service information is stored in other units on the networks.

Referring to FIG. 5, The LAN 400 in the main office further includes a general-purpose server 700. The main database 600 is placed in the general-purpose server 700. Besides, the LAN 410 includes a general-purpose server 710. The backup database 610 is placed in the general-purpose server 710. On the other hand, the IP telephony service backup unit 120 connected to the LAN 420 is provided with the backup database 620. That is, in the construction of the IP telephony service system according to the present invention, the databases may be placed either inside or outside the backup servers.

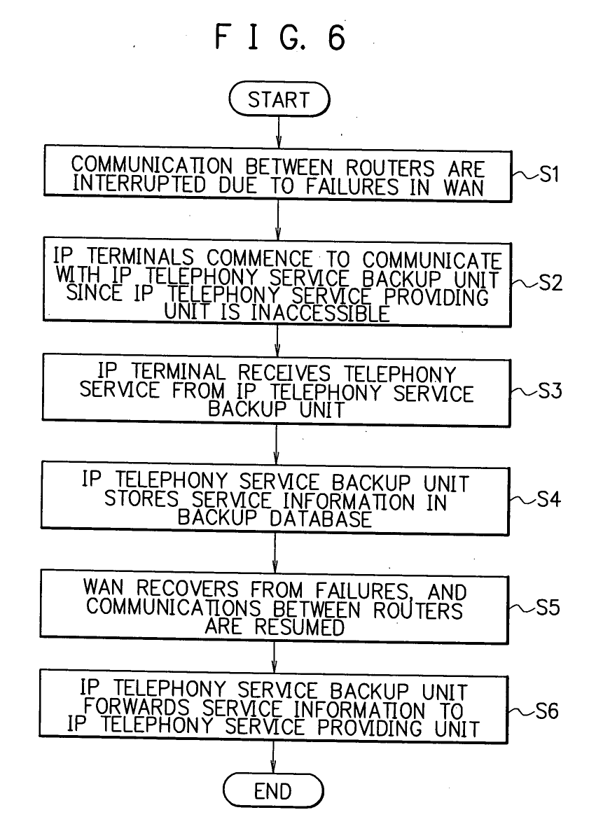

In the following, the operation of the IP telephony service system will be described with reference to FIG. 6.

When communications between the routers 300 and 310 are interrupted or cut off due to failures or traffic congestion in the WAN 500 or the like (step S1), the IP terminals 210 and 211 commence to communicate with the IP telephony service backup unit 110 since the IP telephony service providing unit 100 is inaccessible (step S2).

Incidentally, the failures or traffic congestion can be detected by health checks which are carried out at regular intervals to check whether communications are performed normally. For example, if an IP network such as a WAN, which connects respective LANs, has been congested through a number of health checks, the IP telephony service providing unit 100 is determined to be inaccessible.

Having provided an IP telephony service to the IP terminal 210 (step S3), the IP telephony service backup unit 110 stores information on the service provided to the IP terminal 210 in the backup database 610 (step S4).

When the WAN 500 recovers from the failures or the traffic congestion is relieved, and the communications between the routers 300 and 310 are resumed (step S5), the IP telephony service backup unit 110 forwards the service information stored in the backup database 610 during backup operation to the IP telephony service providing unit 100 (step S6).

As set forth hereinabove, in accordance with the present invention, when communications between the IP terminals and the IP telephony service providing unit in the main network are interrupted, the IP telephony service backup unit placed in a sub network to which the IP terminals are connected provides IP telephony services to the IP terminals, and information on the services provided by the IP telephony service backup unit is stored in the backup database or the second storage. Thereby, it becomes possible to charge for the services provided during backup operation.

In addition, the service information stored in the second storage is forwarded to the main database or the first storage placed in the main network when the IP telephony service providing unit resumes the IP telephony service. Thus, the management of the provided services is facilitated, and it is possible to make the charges according to the services.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An IP telephony service system for offering IP telephony services to IP terminals, comprising a main network and a plurality of sub networks, wherein:
the main network includes an IP telephony service providing unit for providing IP telephony services to IP terminals; and
each of the sub networks includes an IP telephony service backup unit for providing IP telephony services when communications between the IP terminals and the IP telephony service providing unit in the main network are interrupted.

2. The IP telephony service system claimed in claim 1, wherein:
the main network further includes a first database for storing information on services provided to the IP terminals in cooperation with the IP telephony service providing unit; and
each of the sub networks further includes a second database for storing information on services provided to the IP terminals by the IP telephony service backup unit in cooperation with the IP telephony service backup unit.

3. The IP telephony service system claimed in claim 1, wherein:
the main network further includes a first database for storing information on services provided to the IP terminals in cooperation with the IP telephony service providing unit;
each of the sub networks further includes a second database for storing information on services provided to the IP terminals by the IP telephony service backup unit in cooperation with the IP telephony service backup unit; and
the service information stored in the second database is forwarded to the first database so as to be stored therein when the IP telephony service providing unit resumes the IP telephony service.

4. The IP telephony service system claimed in claim 1, wherein:
the main network further includes a first service information management unit for storing and managing information on services provided to the IP terminals; and
each of the sub networks further includes a second service information management unit for storing and managing information on services provided to the IP terminals by the IP telephony service backup unit.

5. The IP telephony service system claimed in claim 1, wherein:
the main network further includes a first service information management unit for storing and managing information on services provided to the IP terminals;
each of the sub networks further includes a second service information management unit for storing and managing information on services provided to the IP terminals by the IP telephony service backup unit; and
the service information stored in the second service information management unit is forwarded to the first service information management unit so as to be stored therein when the IP telephony service providing unit resumes the IP telephony service.

6. The IP telephony service system claimed in claim 1, wherein:
the IP telephony service providing unit has a first storage for storing information on services provided to the IP terminals; and
the IP telephony service backup unit has a second storage for storing information on services provided to the IP terminals by the IP telephony service backup unit.

7. The IP telephony service system claimed in claim 1, wherein:
the IP telephony service providing unit has a first storage for storing information on services provided to the IP terminals;
the IP telephony service backup unit has a second storage for storing information on services provided to the IP terminals by the IP telephony service backup unit; and
the service information stored in the IP telephony service backup unit is forwarded to the IP telephony service providing unit so as to be stored therein when the IP telephony service providing unit resumes the IP telephony service.

8. An accounting method for an IP telephony service system that offers IP telephony services to IP terminals, comprising the steps of:
providing IP telephony services to IP terminals through an IP telephony service providing unit placed in a main network, and storing service information fed by the IP telephony service providing unit in a first storage placed in the main network; or
providing IP telephony services to IP terminals through an IP telephony service backup unit placed in a sub network where the IP terminals are connected when communications between the IP terminals and the IP telephony service providing unit in the main network are interrupted, and storing service information fed by the IP telephony service backup unit in a second storage placed in the sub network.

9. The accounting method claimed in claim 8, further comprising the step of forwarding the service information, which was stored in the second storage while communications between the IP terminals and the IP telephony service providing unit in the main network were interrupted, to the first storage to store the information therein when the IP telephony service providing unit resumes the IP telephony service.
